(19) United States
(12) Patent Application Publication
(10) Pub. No.: US 2018/0330434 A1
(43) Pub. Date: Nov. 15, 2018

(54) Computerized Method, Computer System and Computer Program Product for Providing a User With Personalized Financial Information

(71) Applicant: MASTERCARD INTERNATIONAL INCORPORATED, Purchase, NY (US)

(72) Inventors: Shivendra Dubey, Pune (IN); Ajay Sinha, Pune (IN); Pravin Parekh, Pune (IN); Neeraj Dase, Pune (IN); Sagar Suresh Sonawane, Pune (IN)

(21) Appl. No.: 15/976,446

(22) Filed: May 10, 2018

(30) Foreign Application Priority Data
May 11, 2017 (SG) 10201703865Q

(51) Int. Cl. G06Q 40/02; G06Q 40/06; G06Q 10/06

(52) U.S. Cl. CPC G06Q 40/02; G06Q 10/067; G06Q 40/06

(57) ABSTRACT

A method is proposed for providing a user with financial information. Financial data describing actual financial transactions made by a user is used to define a fictional scenario describing the financial situation of a character associated with at least one financial account. The fictional scenario is allowed to evolve, with input from the user to control actions taken by the character, and it is determined whether the final state of the fictional scenario complies with goal criteria. Thus, the user is presented with an enjoyable, partially fictionalized version of his or her own financial situation, and can learn appropriate behaviors to achieve financial goals. Advice may be generated to the user as to how to do this.

### CROSS-REFERENCE TO RELATED APPLICATION

This application claims the benefit of and priority to Singapore Patent Application No. 10201703865Q filed May 11, 2017. The entire disclosure of the above application is incorporated herein by reference.

### FIELD

The present disclosure relates to computerized methods, computer systems, and computer program products for proving a user with personalized financial information, and, in particular, information for helping the user make financial decisions.

### BACKGROUND

This section provides background information related to the present disclosure which is not necessarily prior art.

Individuals have to make many financial decisions in their lifetime, to help them achieve overall financial goals, such as paying off debt, saving for large purchases (e.g., a house or car), and/or saving for retirement. Software products exist to help users to do budgeting and even make financial investments, but they appeal only to individuals with certain personality types. Many users find using the software tedious and unintuitive, and so they fail to fully understand the risks and advantages of financial strategies the software suggests. Furthermore, it is laborious for a user of one of the software products, both to describe his or her financial situation, and to take action based on the budgeting and investment advice.

### SUMMARY

This section provides a general summary of the disclosure, and is not a comprehensive disclosure of its full scope or all of its features. Aspects and embodiments of the disclosure are set out in the accompanying claims.

In general terms, the present disclosure aims to provide new and useful computerized methods, computer systems and computer program products, to help a user make financial decisions.

In general terms, the disclosure proposes that a computer system employs financial data describing the real financial status of the user (e.g., actual assets and/or liabilities of the user at one or more times, and/or actual financial transactions made by a user), to define a fictional scenario describing the financial situation of a fictional character associated with at least one financial account and having a financial status resembling that of the user. Evolution of fictional scenarios is simulated, with input from the user to control actions taken by the character, and it is determined whether a final state of the fictional scenario complies with goal criteria.

Thus, the user is presented with an enjoyable computational environment in which to learn the results of taking various actions. In other words, the provision of financial information to the user has been “gamified”, i.e., although it is not just a game, it resembles a game rather than a conventional learning environment for financial advice. The computational environment is a partially fictionalized version of the user's actual financial situation, and so the user can learn appropriate behavior to achieve his or her financial goals.

The financial data is obtained automatically, such as from a financial institution where the user maintains an account, so that the fictional scenario is informative about the user's actual financial situation, although the work of setting up the fictional scenario is less time-consuming than if the user had had to fully define it manually.

Definitions of the disclosure, and of features of the disclosure, are provided by the claims.

In this document the term “automatic” is used to mean a process performed without human intervention, except optionally for initiation of the process. The term “semi-automatic” is used to mean that a process is performed by a computer with at least some data input from a human.

As used in this document, the term “payment card” refers to any cashless payment device associated with a payment account, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC-enabled devices, and/or computers. Furthermore, the “payment card” may exist only as a data structure (i.e. without physical existence), which is registered with a digital wallet or cloud wallet.

As used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include, but is not limited to, magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. An embodiment of the disclosure will now be described for the sake of example only with reference to the following figures in which:

FIG. 1 shows a computerized network which is an embodiment of the disclosure;

FIG. 2 shows steps of a method which is an embodiment of the disclosure;

FIG. 3 shows schematically the modules of a computer program product, which is an embodiment of the disclosure, for performing the method of FIG. 2;

FIG. 4 shows a graphical user interface generated by the computer program product of FIG. 3;

FIG. 5 shows schematically the construction of a computer server of the computerized network of FIG. 1; and

FIG. 6 shows schematically the construction of a communication device of the computerized network of FIG. 1.

Corresponding reference numerals indicate corresponding parts throughout the several views of the drawings.

### DETAILED DESCRIPTION

Embodiments of the present disclosure will be described, by way of example only, with reference to the drawings. The description and specific examples included herein are intended for purposes of illustration only and are not intended to limit the scope of the present disclosure.

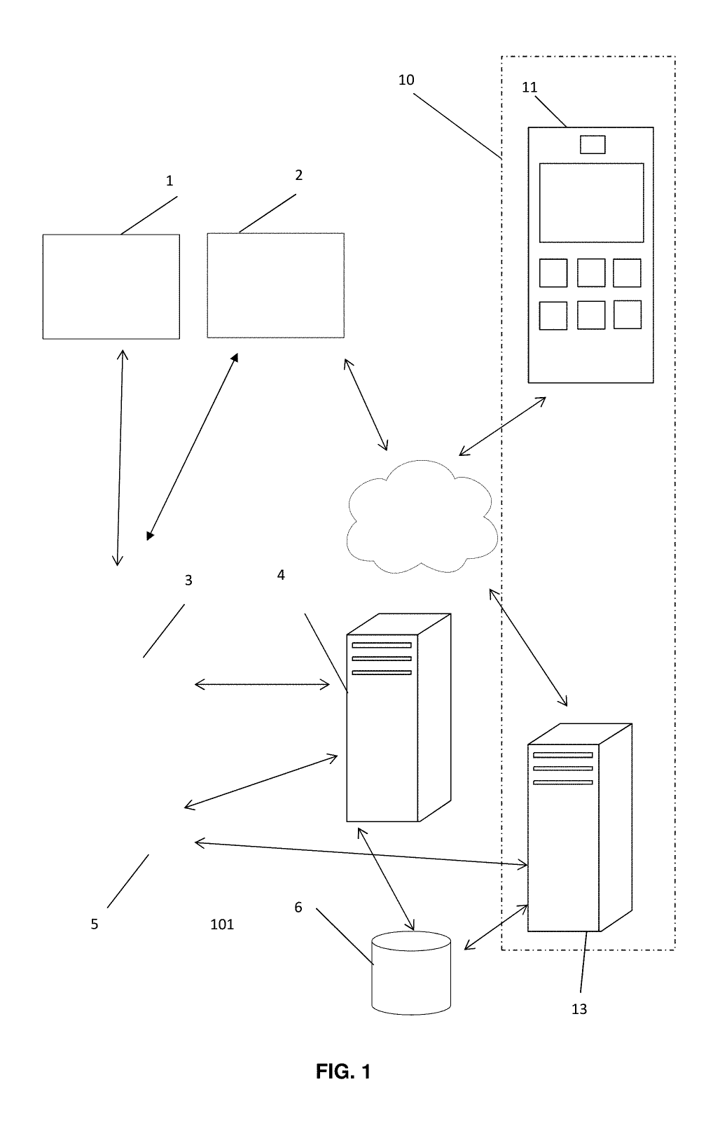

Referring to FIG. 1, a computerized network 10 is shown, which is an embodiment of the disclosure. The computerized network 10 is designed to interact with a known payment network illustrated by the elements with reference numbers 1 to 6.

We will begin by explaining the operation of the conventional payment network. The payment network is for use by multiple individuals (here “users”) who each hold at least one respective payment card issued by a corresponding issuer bank. A user goes to a POS (point-of-sales) terminal 1 operated by a merchant to make a purchase of a product, which may be a physical object, a data product (such as music or software) or a service. The POS terminal 1 reads the details of the payment card, and sends them, together with data including the amount of the purchase, to an acquirer bank server 3 of an acquirer bank at which the merchant maintains an account. The acquirer bank server 3 contacts a payment network server 4 of the payment network, and sends the payment network server 4 an authorization request comprising the payment card details and the amount of the purchase. The payment network server 4 uses the payment card details to identify the issuer bank. The payment network server 4 contacts an issuer bank server 5 operated by the issuer bank, and sends the payment card details and the amount of the purchase. The issuer bank server 5 decides either to authorize the purchase, or not to, and sends a corresponding message to the payment network server 4. The payment network server 4 passes this information to the acquirer bank server 3, which passes the message back to the POS terminal 1. If the issuer bank server 5 authorized the transaction, then the purchase is now completed: the payment (optionally plus a handling fee) is debited to the user's account at the issuer bank, and credited (optionally minus a handling fee) to the merchant's account at the receiver bank. At some later time (during clearing and settlement operations), the issuer bank transfers the payment amount to the acquirer bank.

The same basic scheme is used when the user, instead of using the POS terminal 1, uses a communication device 11 associated with the user to contact, using a communication network 12, a server 2, which functions as an online store. The communication device 11 may be a smart phone, a tablet computer or a PC. In this case, the online store server 2 replaces the POS terminal 1 in the payment process described in the preceding paragraph. The user enters the payment card details into the communication device 11, or they may be pre-stored there. Upon a payment transaction being instructed, the online store 2 sends the payment card details and the payment amount to the acquirer bank server 3 of the acquirer bank where the merchant operating the online store 2 maintains an account (for simplicity this is assumed to the be same acquirer bank where the merchant operating the POS terminal 1 maintains an account). The acquirer bank server 3 sends an authorization request to the payment network server 4, which passes it to the issuer bank server 5. The result is relayed back via the payment network server 4 to the acquirer bank server 3, and then to the online store server 2. If the issuer bank server 5 authorized the transaction, then the purchase is now completed: the payment (optionally plus a handling fee) is debited to the user's account at the issuer bank, and credited (optionally minus a handling fee) to the merchant's account at the receiver bank. At some later time (during clearing and settlement operations), the issuer bank transfers the payment amount to the acquirer bank.

Mastercard® Inc. operates a system called Masterpass®, which is a digital wallet. In this system, the GUI generated by the online store server 3 gives the user the option (e.g., in the form of a “button”) to initiate the payment transaction using a payment card, which has previously been registered with an API (application programming interface) operating the digital wallet, and running on the issuer bank server 5 or the payment transaction server 4. Upon the user initiating the transaction, the online store server 3 initiates communication between the communication device 11 and the API. The user verifies his or her identity to the API, and in the case that the user has registered multiple payment cards with the digital wallet, chooses one of those payment cards. Upon this happening, the API extracts details of the user's payment card from the database, and uses them to initiate the transaction described above. For example, the API may pass them to the online store server 2, so that the online store server 2 can include them in the data the online store server 2 sends to the acquirer bank server 3. Thus, the user does not have to enter his or her payment card details into the online store server 2.

Both in the case of a payment to a POS terminal 1, and to an online store server 2, the payment network server 5 maintains a record of the transaction in the database 6.

We now turn to a description of the computerized network 10, which is an embodiment of the disclosure. The computerized network 10 includes the user's communication device 11 and a server 13, which has access to the database 6 storing payment transaction data and/or is in communication (e.g., via the payment network server 4 or directly over a communication network) with the issuer bank server 5. The communication device 11 and server 13 communicate via a conventional communication network 12. (Alternatively, the computerized network 10 might be considered as including the communication network 12.)

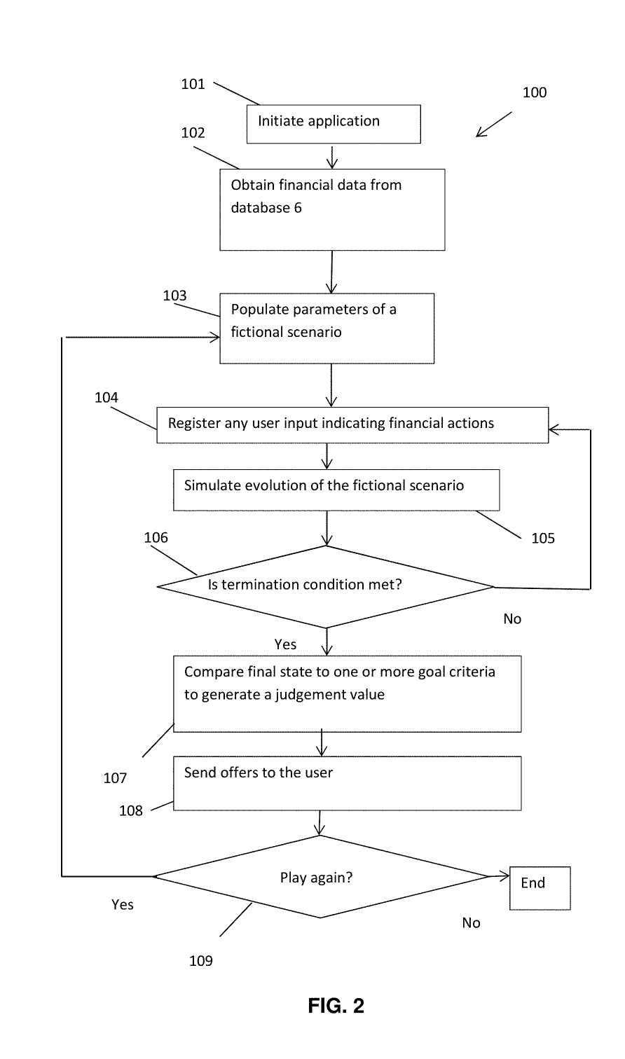

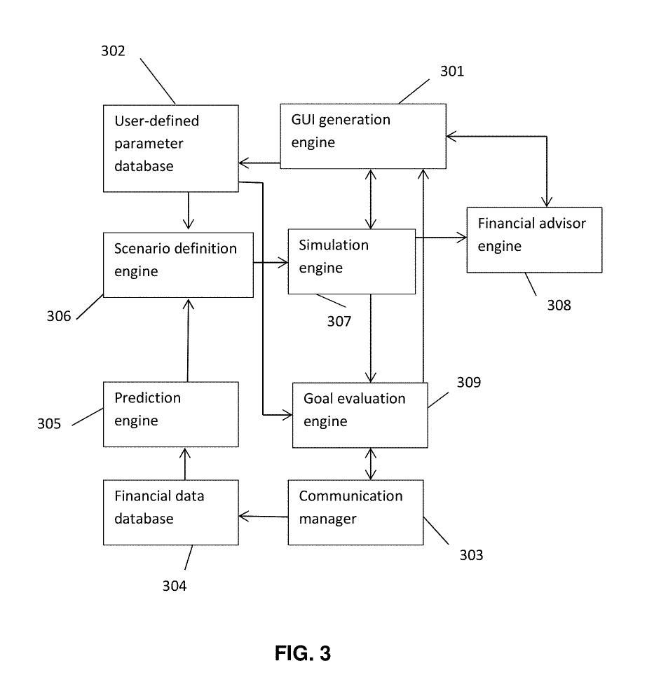

The communication device 11 runs an application (“app”), which is a computer program product, which is an embodiment of the disclosure. The communication device 11 is itself a computer system, which is an embodiment of the disclosure, and performs a method 100, which is an embodiment the disclosure, and which is illustrated in FIG. 2. Modules of the app are shown in FIG. 3. The method 100 provides the user (the operator of the communication device 11) with financial information relevant to his or her financial situation, and trains the user about which financial actions are desirable to achieve financial goals. The user's interaction with the application is intended to be enjoyable, and in this sense resembles a game.

The application presents financial information to the user in the form of information about the financial status of a fictional character in a financial scenario based on and resembling the financial status of the user. The fictional scenario is defined as starting at a “start time” in a fictional world (“universe”) in which the character lives. The start time may or may not correspond to a date in the real world. If it does, the start time may, for example, be the date on which the application is run. The fictional scenario runs over a period from the start time to a final time in the fictional universe later than the start time. The set of times in the fictional universe between the start time and the final time are referred to here as the financial period. As described below, the final time may be predefined in relation to the start time (e.g., at least a fortnight later, one month later, or a certain number of months and/or years later), or may be determined based on the evolution of the fictional scenario.

The first step 101 of the method is the initiation of the application. In this step the user interacts with a graphical user interface (GUI) generated by a GUI generation module 301 of the app, to select one or more user-defined parameters, which are used to control the operation of the application. The user-defined parameters are stored in a user-defined parameter database 302.

The user-defined parameters may include a selection of one or more “financial missions”, such as building up savings, paying off debt or saving for retirement. Each of the financial missions is a set of one or more goal criteria. One or more of these goal criteria may be associated with a numerical parameter. For example, the goal criteria for “build up savings” might be that at the end of a certain period (e.g., a month) the character has saved a certain amount of money. Step 101 may include setting that amount of money (e.g., by allowing the user to specify it using the GUI).

The user-defined parameters may further include one or more presentational options. For example, as described below, during the operation of the application the user is given financial advice by a simulated financial advisor, and step 101 may include selecting presentational parameters of the financial advisor, for example, by selecting one of a plurality of avatars to be displayed as a personification of the financial advisor.

In step 102, a data interface of the communication device 11, under the control of a communication manager 303 of the app, communicates via the communication system 12 with the server 13 and obtains from the server 13 financial data describing real financial information associated with the user. To do this, the app may be provided with security information, which allows the communication manager to perform a “log-in” procedure with the server 13. The financial information may include numerical values for actual assets/liabilities of the user at one or more corresponding times, and or payment transactions to/from a real financial account associated with the user.

The server 13 may obtain some or all of this data from the database 6. Alternatively, or additionally, the server 13 may be able to communicate directly with the issuer bank server 5 (either directly or via the payment transaction server 4) to obtain data from the issuer bank server 5. This may have the advantage that the financial data is not limited to payment transactions made using the payment card, but can include financial information about all financial accounts the user may maintain with the issuer bank. The communication manager 303 transfers the financial data into a financial data database 304.

Step 103 may include, or even consist of, obtaining financial data other than through the communication interface. For example, the communication device 11 may include an application which the user uses to make and/or receive purchases, such as an application associated with an issuer bank. If this application stores financial data within the communication device, that financial data may be transferred to the financial data database 304 in step 102. In another example, the user may use a messenger application running on the communication device 11 to send messages (e.g. SMS messages) relating to payments to/from the user, and the app may be able to extract financial data from the messages to populate the financial data database 304.

In step 103, a prediction engine 305 of the app uses the financial data obtained in step 102 to generate parameters of a fictional scenario. The parameters are used by a scenario definition engine 306 to define the fictional scenario. The fictional scenario is defined in terms of: (a) initial parameters at a start time of the financial scenario (e.g., an amount of money stored in a financial account of the character), and (b) update parameters which specify how the fictional scenario is updated at respective times during the financial period (e.g., by payment into or out of the financial account of the character). At least some of the initial parameters and the update parameters are generated by the prediction engine 305 based on the financial data, so the fictional scenario resembles the actual financial status of the user (at least at the start time).

For example, the financial data may include data describing regular payments made to the user (e.g. the user's wage, or rent paid to the user from a property the user owns and rents out; or dividend, pension or annuity payments), and regular payments made by the user (e.g. rental payments and standing orders for utility bills or other services). The prediction engine 305 may use the information about the regular payments to populate the update parameters of the fictional scenario so as to indicate that the character receives payments in the fictional universe of the same amount and with the same regularity as actual user does in the real world, according to the financial data. The update parameters may, for example, be such as to specify that payments are made on a certain day-of-the month during the financial period.

In the case that payments made to the financial account comprise data describing irregular actual payments to the user (e.g., because the user is self-employed, and receives irregular payments for individual work projects carried out) and/or irregular actual payments by the user (e.g., due to discretionary spending of the user), the app may be operative to generate update parameters, which statistically match the irregular payments. For example, the update parameters may describe payments at randomly-chosen times in the financial period, including payments made by the character having the same average and/or standard deviation as the actual payments made by the user, and/or including payments made to the character having the same average and/or standard deviation as actual payments made to the user.

Optionally, the prediction engine 305 may be also be operative to select and/or modify at least some of the goal criteria based on the financial data.

For example, the “financial mission” may be chosen, or at least proposed to the user via the GUI, by the prediction engine 305 based on the financial data, and/or any demographic data about the user which is available. The demographic data may describe any one or more of, for example, the user's age, gender, marital status, educational level, job, number of children, ages of children, etc.

In another example, the prediction engine 305 may be operative to set a level of a numerical parameter associated with one of the goals (e.g., an amount of money to be saved during the financial period) based on the user's assets and liabilities, and/or the demographic data.

Step 103 may further include the scenario definition engine 306 receiving further user-defined parameters, e.g., from the user-defined parameter database. For example, as part of step 101 the user may have been enabled to define user-defined parameters, which define payments the user knows he or she will make or receive, and which are not represented by the financial data. For example, if a user is about to purchase a car, and knows that he or she will have to make regular payments of a certain amount on certain dates, the user is able to specify this as part of step 101, and the user-specified parameters are used by the scenario definition engine 306 in step 103.

The game may include a number of “levels” which the user plays successively. As described below, progress from one level to another may be dependent on meeting some or all of the game criteria. Each level may be associated with a different scenario involving the character and/or use different goal criteria. The scenario definition engine 306 may define the scenario according to parameters (e.g. pre-defined parameters) relating to the level of the game which is currently being played. For example, the standard deviation of at least some of the payments (e.g., the payments by the character) specified by update parameters may be higher at later levels of the game.

In steps 104 to 106 of the method, the “game” is played. This set of steps constitutes a loop, which may be performed repeatedly, for example once per second.

In step 104, it is determined whether the user has provided data input to the GUI to specify a financial action taken by the user. The financial action may, for example, include reducing the amount of one of the payments by the character specified by the prediction engine 305, to indicate a cost saving the character has made. Alternatively, the financial action could include making payments (e.g., of a user-defined amount) to a savings account.

In step 105, a simulation engine 307 calculates an evolution of the fictional scenario defined by the scenario definition engine, taking into account any financial action specified by the user in step 104. For example, if the financial action was to reduce one of the payments by the character specified by the prediction engine 305, then the simulation engine would indicate that the fictional character's account is debited for the reduced payment amount, rather than the original amount. If the financial action was making a payment to a savings account, then the simulation engine would debit that amount from the account of the character, at the times when the payment was made, and credit the amount to the savings account.

In one case, each time the loop of steps 104-106 is carried out may correspond to a step through the financial period from the start time to the final time, so that as the loop is played successive times, the scenario is correspondingly updated stepwise, from the start time to the final time.

Alternatively, in each loop of steps 104-106, the simulation engine may simulate how the scenario evolves over the whole financial period due to actions the user specifies in that loop. For example, if, in step 104 of a given loop, the user specifies that an investment is made at a certain time during the financial period, step 105 would include predicting the whole of the evolution of the financial scenario to the final time in view of that investment. Thus, the “game” could consist of the user repeatedly instructing financial actions for the character to take at different times in the financial period (not necessarily times in a chronological order within the financial period), and thereby trying to make the scenario at the end of the final time meet the goal criteria.

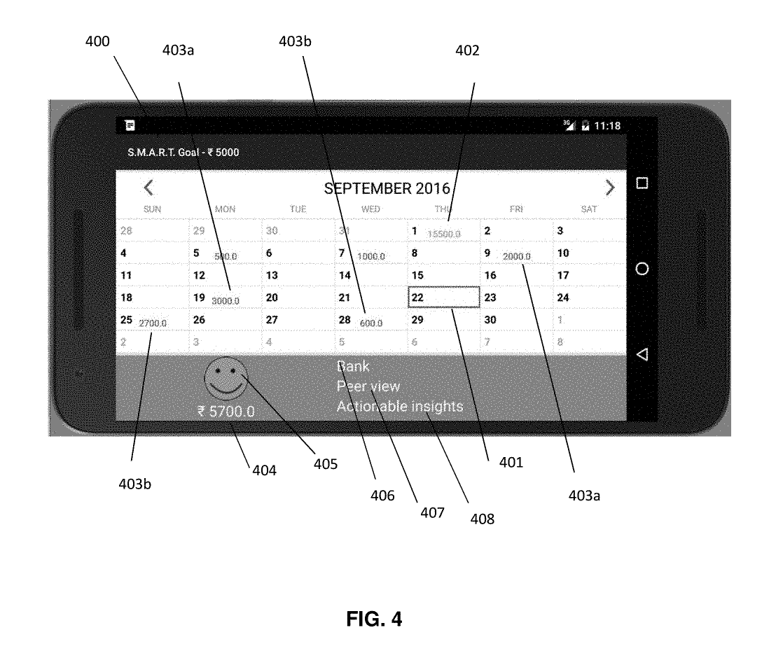

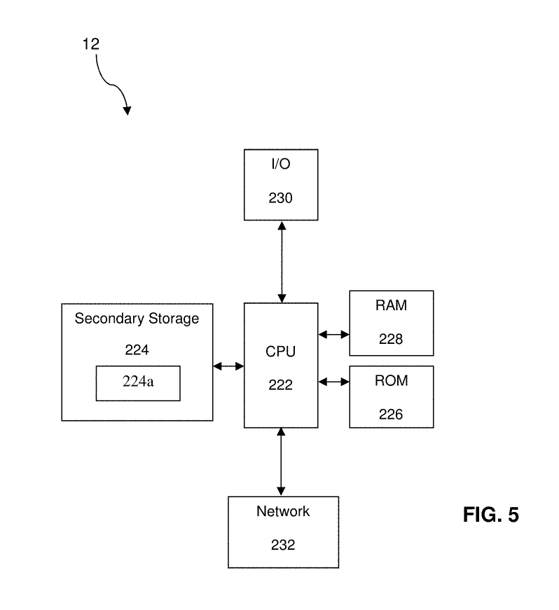

Step 105 includes the simulation engine 307 commanding the GUI generation engine 301 to generate a visual representation of the fictional scenario. An example is shown in FIG. 4, in which the financial period is one or more months in the fictional universe, and the visual representation is in the form of a calendar showing a selectable month of the financial period. In the case of FIG. 5, this is September 2016 in the fictional universe.

The “game” in this case is played by stepping through the financial period with one loop corresponding to one day of the financial period. An area 400 of the GUI shows the goal of this level of the game: “S.M.A.R.T. Goal—$5000”. This level of the game has a single goal criterion: to save $5000 in the month. The current day is 22 September (in the fictional universe), and is indicating in the GUI by the box 401. Payments to the character's account of the fictional character are shown by numbers 402 (e.g., in a first colour) on the days when the payment was received (i.e., the day when it was received by the bank, or the day when the payment was credited to the character's account).

Past payments from the character's account are shown by numbers 403a (e.g., in another colour) on the days when the payment was debited from the customer account. Expected future payments from the character's account (i.e., payments after the current day) are shown by numbers 403b. These are estimated by looking at the customer's past transactional history/spend data, and may include any standing payment instructions the customer has given the bank (e.g., to make a payment of a certain amount to a certain account on a certain day of each month). Also, although not shown in FIG. 4, the GUI may show any future payments, which are expected into the character account during the month.

Although not shown in FIG. 4, the box 401 for the current day may show a total of (i) any payments which have already debited to the character's account on the current day, and (ii) any payments expected to be made from the character's account on the current day, but which have not yet been made. Box 401 may also show a total of (i) any payments which have already been received by the character's account on the current day, and (ii) any payments expected to be received by the character's account on the current day, but which have not yet been received.

An area 404 indicates an amount of money ($5700), which the simulation engine 307 predicts will be saved during the month (i.e., it is a prediction of the balance on the last day (the 30^{th}) of the current month (September) after making all the expected future payments 403b and taking into account any future payments expected into the account). In other words, the amount of money shown in area 404 is equal to the account balance at the start of the current month minus all the payments which have been made until 22 September, plus any payments received by 22 September, and adjusted by the expected payments 403b from the account, and any payments which are expected that the account will receive.

The area 405 displays an icon indicating that the amount is in-line with the goal criteria. The simulation engine may obtain this information from a goal evaluation engine 309, which compares the evolved scenario generated by the simulation engine with the goal criteria set in step 101 and/or step 103.

Selectable (e.g., clickable) regions 406, 407, 408 are provided in the GUI in which the user can obtain information or perform specific actions.

If the user selects (e.g., clicks on) the area 406 (which the GUI labels “bank”) after the user has achieved the goal criterion or criteria for a given level, the user is taken to a screen where the user is able to enter commands to save a certain sum (e.g., the goal amount) in a financial instrument.

The user may be given advice about what investment options to take (for example, in equities and or in a fixed interest deposit account). This is in the form of action proposal data generated by a financial advisor engine 308. Software which would be able to fulfill this function is already publicly available. The action proposal data may be generated by the financial advisor engine 308 using the financial data and/or parameters of the financial scenario. Alternatively or additionally, it may employ the goal criteria. Thus, the user is provided with a “virtual financial advisor”, providing advice which the user is able to exploit in the real word, e.g., after having learnt from the application how effective it will be at achieving the goals.

The financial advisor engine 308 may, using the GUI generation engine 301, obtain data from the user selecting one of more pre-defined categories of options the user wishes to take, e.g. investments with a specified risk level (e.g., “high” or “low”). If the user indicates a willingness to accept high risk investments, the financial advisor engine 308 may suggest equities investments. If the user indicates no willingness to accept high risk investments, the financial advisor engine 308 may suggest fixed deposit investments.

If the user indicates, using the GUI, that a certain option is to be taken, that information is registered in step 104, and used by the simulation engine 307 on subsequent occasions when step 105 is performed. For example, the simulation engine 307 may simulate possible performance of an investment vehicle selected by the user.

If the user selects (e.g., clicks on) the area 407, the user is taken to a screen, which displays a comparison between the evolved financial scenario and performance data, which is statistically representative of the final states of respective scenarios for a plurality of second users. The comparison may be performed by the goal evaluation module 309. The goal evaluation module may obtain the performance data by communicating with the server 13, using the communication manager 303. The comparison may, for example, indicate that the character has saved during the financial period a sum of money, which is a certain multiple of the average of sums of money saved by the second users.

Optionally, the app may have profile data for the user comprising demographic data about the user (e.g., one or more of age, gender, job-type, educational level, salary level, etc.). For example, the user may have entered the demographic data in step 101 of the method. In this case, the goal evaluation engine 309 may use the profile to obtain the performance data in respect of second users who have respective profiles, which match the demographic profile of the user according to one or more similarity criteria. For example, the goal evaluation engine 309 may transmit the profile data and data describing the financial scenario, to the server 13, which may maintain a database of performance data for each of a plurality of sets of users defined based on the similarity criteria. The server 13 may use the profile data for the user to identify the corresponding performance data for second users, which match the demographic profile of the user according to the one or more similarity criteria, compare that to the data describing the financial scenario, and transmit the result to the GUI generation engine 301 via the communication manager 303 for display to the user.

In a variation of this, the goal evaluation manager 309 does not necessarily send out of the communication device 11 the data describing the scenario; instead, the goal evaluation engine 309 obtains performance data from the server 13, and forms the comparison itself between the scenario and the performance data.

If the user selects (e.g., clicks on) the area 408, the application presents a GUI to the user, which the user can use to obtain insights into his or her spending.

The financial advisor engine 308 may analyze the financial data, and/or the scenario simulated by the simulation engine 307, to obtain data characterizing the financial status of the user, and display features of note to the user. For example, the financial advisor engine 308 may point out any unusual features it may have. For example, the financial advisor engine 308 may point out to the user any spending category which is unusually high.

In another example, the user may be able to ask the application a text question, for example, by typing the question into a text entry box which is displayed. The question may be “what is the highest spend category in this month”. In response, the application will analyze the spend data, and determine how much spending was in each of a number of predetermined categories, and display a result (e.g., “Movies”).

Optionally, the financial advisor engine 308 may perform an action (e.g., generate a notification) to the user if certain criteria are met. For example, if the total of a certain category of spending reaches a threshold in the scenario, e.g., within a certain period in the fictional universe, then an alert may be generated to the user. For example, if the user sets an alert for the category “Movies” if the character spends more than a defined sum (e.g., selected by the user as part of setting up the alert) in the fictional universe, the application may transmit an alert to the user. The alert may be in the form of a notification in the application, or an SMS (short messaging service) or email message, etc., when the character has spent the defined sum on movies.

Optionally, the application may also perform an action defined by the financial advisor engine if further financial information is received by the application subsequently (i.e., indicating the financial status of the user after the game has been played). For example, a user notification may be generated to the user if the application receives financial data indicating that the total spend in the real world in a certain category has reached a threshold. For example, if the user sets an alert for the category “Movies” if the user spends more than a defined sum (e.g., selected by the user as part of setting up the alert) in the real universe, the application may transmit an alert to the user. The alert may be in the form of a notification in the application, or an SMS (short messaging service) or email message, etc., when the user has spent the defined sum on movies.

In step 106 of the method 100, the app evaluates whether at least one termination criterion is met. If not, the method 100 loops back to step 103.

The termination criterion may, for example, be that the loop of steps 104, 105, 106 has been performed a certain predefined number of times. If, as discussed above, performance of the loop corresponds to taking a step through the financial period, this would correspond to a predefined final time having been reached.

Alternatively, the termination criterion might be such that it can be determined (e.g., by the goal evaluation engine 309) that the goal criteria will have been met by the final period. For example, the screen of FIG. 4 indicates that that simulation engine 307 has determined that a savings goal of saving more than $5000 will be accomplished; and upon this being determined, the loop may terminate.

Alternatively, the termination criterion might be that a certain command is received from the user.

A combination of these possible termination criteria may be used (e.g., step 106 may give a “yes” result if any one of the criteria is met).

In step 107 a comparison is performed of the final state of the scenario with the goal criteria. This generates a judgement value indicating whether the goal criteria were met. (Note that in the case that one of the termination criteria is that the goal criteria are met, then steps 108 and 106 may be considered a single step.)

In step 108, based on the judgement value, one or more offers may be made to the user. For example, if the user is determined in step 107 to have completed the goals, then the one or more offers may be made. These are typically offers for the user to make a real-world payment, e.g. a purchase or investment.

Optionally, the offer may be conditional on the payment being made using a designated financial account associated with the user. For example, the user may be presented with a first offer which is applicable if the payment is made using the designated financial account, and a second offer with a higher payment amount, which is applicable if the payment is made other than using the designated financial account.

In step 109, it is determined whether the user should play again. Typically, the result of step 109 is “yes” unless both of the following conditions are met: (a) the level of the game which has just been played is the final level; and (b) the judgement value obtained in step 107 for that level indicates that the goals were met. If not, the method 100 ends. If so, the method 100 loops back to step 103.

If the judgement value obtained in step 107 indicates that the user met the goal criteria, step 103 may be repeated with different parameters, to define a more advanced level of the game. For example, the goal criteria may be different (e.g., a savings goal level at level 1 could be 500 USD; at level 2, 1000 US dollars, etc.).

Several variations of the scheme above are possible within the scope of the disclosure. For example, in one variation the server 13 may be identical with (i.e., integrated with) the payment network server 5 which operates the payment network.

In another variation, the server 13 may be identical with (i.e., integrated with) the issuer bank server 5.

FIG. 5 is a block diagram showing a technical architecture of the server 13. The technical architecture includes a processor 222, (which may be referred to as a central processor unit or CPU), that is in communication with memory devices including secondary storage 224 (such as disk drives), read only memory (ROM) 226, random access memory (RAM) 228. The processor 222 may be implemented as one or more CPU chips. The technical architecture may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs, which are loaded into RAM 228 when such programs are selected for execution.

In this embodiment, the secondary storage 224 has an order processing component 224a comprising non-transitory instructions operative by the processor 222 to perform various operations of the method of the present disclosure. The ROM 226 is used to store instructions and, perhaps, data, which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts, which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 222, the RAM 228, and the ROM 226 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

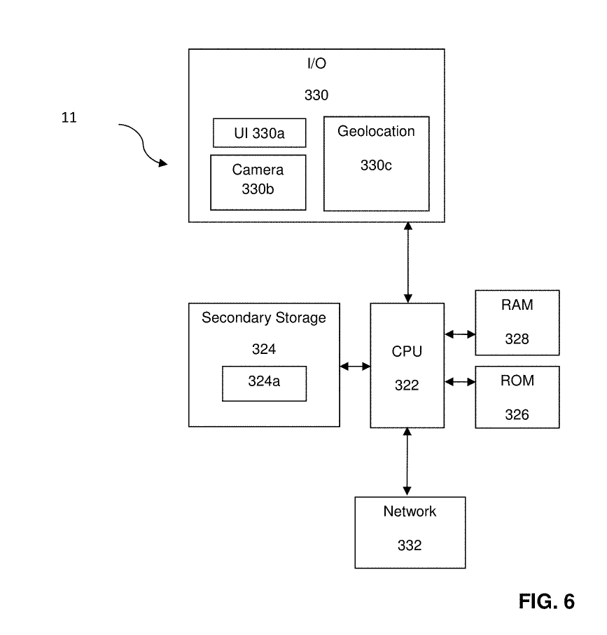

FIG. 6 is a block diagram showing a technical architecture of the communication device 11. It is envisaged that in embodiments, the communication device 11 will be a smartphone or tablet device, but it may also be a personal computer (desktop or laptop).

The technical architecture includes a processor 322, (which may be referred to as a central processor unit or CPU), that is in communication with memory devices including secondary storage 324 (such as disk drives or memory cards), read only memory (ROM) 326, random access memory (RAM) 328. The processor 322 may be implemented as one or more CPU chips. The technical architecture further comprises input/output (I/O) devices 330, and network connectivity devices 332.

The I/O devices comprise a user interface (UI) 330a, a camera 330b and a geolocation module 330c. The UI 330a may comprise a touch screen, keyboard, keypad or other known input device. The camera 330b allows a user to capture images and save the captured images in electronic form. The geolocation module 330c is operable to determine the geolocation of the communication device using signals from, for example, global positioning system (GPS) satellites.

The secondary storage 324 is typically comprised of a memory card or other storage device and is used for non-volatile storage of data and as an over-flow data storage device if RAM 328 is not large enough to hold all working data. Secondary storage 324 may be used to store programs, which are loaded into RAM 328 when such programs are selected for execution.

In this embodiment, the secondary storage 324 has an order generation component 324a, comprising non-transitory instructions operative by the processor 322 to perform various operations of the method of the present disclosure. The ROM 326 is used to store instructions and, perhaps, data, which are read during program execution. The secondary storage 324, the RAM 328, and/or the ROM 326 may be referred to in some contexts as computer readable storage media and/or non-transitory computer readable media.

The network connectivity devices 332 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 332 may enable the processor 322 to communicate with the Internet or one or more intranets. With such a network connection, it is contemplated that the processor 322 might receive information from the network, or might output information to the network in the course of performing the above-described method operations. Such information, which is often represented as a sequence of instructions to be executed using processor 322, may be received from and outputted to the network, for example, in the form of a computer data signal embodied in a carrier wave.

The processor 322 executes instructions, codes, computer programs, scripts) which it accesses from hard disk), floppy disk, optical disk (these various disk based systems may all be considered secondary storage 324), flash drive, ROM 326, RAM 328, or the network connectivity devices 332. While only one processor 322 is shown, multiple processors may be present. Thus, while instructions may be discussed as executed by a processor, the instructions may be executed simultaneously, serially, or otherwise executed by one or multiple processors.

Whilst the foregoing description has described exemplary embodiments, it will be understood by those skilled in the art that many variations of the embodiment can be made within the scope and spirit of the present disclosure.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computerized method of providing a user with personalized financial information, the method comprising:
obtaining, by a computer system, from a database, financial data describing real financial information associated with the user;
based on the financial data, populating, by the computer system, parameters of a fictional scenario describing the financial situation of a character associated with at least one financial account;
simulating, by the computer system, evolution of the fictional scenario from an initial state at an initial time, to a final state at a final time; and
comparing, by the computer system, the final state to one or more goal criteria, to generate a judgement value, the judgement value indicating whether the final state complies with the goal criteria;
wherein said simulation of the evolution of the financial scenario comprises repeatedly:
receiving data input from the user indicative of financial actions of the character taken between the initial time and the final time; and
based on the data input, modifying evolution of the fictional scenario to simulate the effect on the fictional scenario of the actions.

2. The method according to claim 1, wherein the simulation of the evolution of the financial scenario comprises predicting, using the financial data, at least one of payments to, and payments from, the financial account at corresponding times between the initial time and the final time.

3. The method according to claim 1, wherein populating parameters of the fictional scenario, simulating evolution of the fictional scenario, and comparing the final state to one or more goal criteria are performed successively multiple times, each of the second and subsequent performances being conditional upon the judgement value resulting from the preceding performance indicating that the corresponding final state complies with the goal criteria.

4. The method according to claim 1, further comprising, upon generation of a judgement value indicating that the corresponding final state complies with the goal criteria, offering the user the opportunity to perform a transaction.

5. The method according to claim 4, wherein the transaction is conditional on a payment included in the transaction being made from a designated financial account associated with the user.

6. The method according to claim 1, further comprising:
automatically generating action proposal data characterizing one or more options for financial actions to be taken by the character; and
transmitting the action proposal data to the user;
whereby the user is enabled to use said data input to accept one or more of the options characterized by the proposal data.

7. The method according to claim 6, wherein the proposal data is generated based on at least one of:
the financial data;
parameters of the financial scenario; and
the goal criteria.

8. The method according to claim 1, further comprising generating and transmitting to the user comparison data comparing the final state to performance data statistically representative of the final states of respective scenarios for a plurality of second users.

9. The method according to claim 8, wherein the user is associated with a demographic profile, and the performance data is statistically representative of the final states of respective scenarios for a plurality of second users who have respective demographic profiles which match the demographic profile of the user according to one more similarity criteria.

10. A computer system for providing a user with personalized financial information, the computer system comprising:
a data interface for receiving financial data describing payments associated with the user;
a processor in communication with the data interface; and
a data storage device storing program instructions operative, when run by the processor, to cause the processor to:
based on the financial data, populate parameters of a fictional scenario describing the financial situation of a character associated with at least one financial account;
simulate evolution of the fictional scenario from an initial state at an initial time, to a final state at a final time; and
compare the final state to one or more goal criteria, to generate a judgement value, the judgement value indicating whether the final state complies with the goal criteria;
wherein, in connection with simulating the evolution of the financial scenario, the program instructions cause the processor, repeatedly, to:
receive data input from the user indicative of actions of the character taken between the initial time and the final time; and
based on the data input, modify evolution of the fictional scenario to simulate the effect on the fictional scenario of the actions.

11. The computer system according to claim 10, wherein the program instructions are operative to cause the processor to simulate the evolution of the financial scenario using the financial data to predict at least one of payments to, and payments from, the financial account at corresponding times between the initial time and the final time.

12. The computer system according to claim 10, wherein the program instructions are operative to cause the processor to populate parameters of the fictional scenario, simulate evolution of the fictional scenario, and compare the final state to one or more goal criteria successively multiple times, each of the second and subsequent performances being conditional upon the judgement value resulting from the preceding performance indicating that the corresponding final state complies with the goal criteria.

13. The computer system according to claim 10, wherein the program instructions are operative to cause the processor, upon generation of a judgement value indicating that the corresponding final state complies with the goal criteria, to offer the user the opportunity to perform a transaction; and
wherein the transaction is conditional on a payment included in the transaction being made from a designated financial account associated with the user.

14. (canceled)

15. The computer system according to claim 10, wherein the program instructions are operative to cause the processor to:
generate action proposal data characterizing one or more options for financial actions to be taken by the character; and
transmit the action proposal data to the user;
whereby the user is enabled to use said data input to accept one or more of the options characterized by the proposal data.

16. (canceled)

17. The computer system according to claim 10, wherein the computer system is a user device configured to communicate with a computer server via the communication interface to obtain the financial data.

18. A computer program product for providing a user with personalized financial information, the computer program product comprising program instructions operative, when run by a processor of a computer system comprising the processor and a data interface, to cause the processor to:
receive over the data interface financial data describing real financial information associated with the user;
based on the financial data, populate parameters of a fictional scenario describing the financial situation of a character associated with at least one financial account;
simulate evolution of the fictional scenario from an initial state at an initial time, to a final state at a final time; and
compare the final state to one or more goal criteria, to generate a judgement value, the judgement value indicating whether the final state complies with the goal criteria;
wherein, in connection with simulating of the evolution of the financial scenario, the program instructions cause the processor, repeatedly, to:
receive data input from the user indicative of actions of the character taken between the initial time and the final time; and
based on the data input, modify evolution of the fictional scenario to simulate the effect on the fictional scenario of the actions.

19. The computer program product according to claim 18, wherein the program instructions are operative to cause the processor to simulate the evolution of the financial scenario using the financial data to predict at least one of payments to, and payments from, the financial account at corresponding times between the initial time and the final time.

20. The computer program product according to claim 18, wherein the program instructions are operative to cause the processor to populate parameters of the fictional scenario, simulate evolution of the fictional scenario, and compare the final state to one or more goal criteria successively multiple times, each of the second and subsequent performances being conditional upon the judgement value resulting from the preceding performance indicating that the corresponding final state complies with the goal criteria.

21. The computer program product according to claim 18, wherein the program instructions are operative to cause the processor, upon generation of a judgement value indicating that the corresponding final state complies with the goal criteria, to offer the user the opportunity to perform a transaction; and
wherein the transaction is conditional on a payment included in the transaction being made from a designated financial account associated with the user.

22. (canceled)

23. The computer program product according to claim 18, wherein the program instructions are operative to cause the processor to:
generate action proposal data characterizing one or more options for financial actions to be taken by the character; and
transmit the action proposal data to the user;
whereby the user is enabled to use said data input to accept one or more of the options characterized by the proposal data.

24. (canceled)
